(19) United States
(12) Patent Application Publication
(10) Pub. No.: US 2025/0135675 A1
(43) Pub. Date: May 1, 2025

(54) APPARATUS AND METHOD FOR ORBITAL OPERATION OF A BLADE FOR CUTTING ROLLS

(71) Applicant: O.M.T. S.R.L., MASSA E COZZILE (IT)

(72) Inventor: MARCELLO TOMMASI, MASSA E COZZILE (IT)

(21) Appl. No.: 18/833,634

(22) PCT Filed: Jan. 31, 2023
(86) PCT No.: PCT/IB2023/050831

§ 371 Date: Jul. 26, 2024

(30) Foreign Application Priority Data
Feb. 2, 2022 (IT) 102022000001802

(51) Int. Cl. B26D 7/26; B26D 1/16; B26D 5/00; B26D 7/12

(52) U.S. Cl. CPC B26D 7/2635; B26D 1/16; B26D 5/00; B26D 7/12; B26D 2210/11

(57) ABSTRACT

An apparatus for controlling and operating a circular cutting blade with cutting rolls from reels having support element designed to carry a cutting blade, with a first actuating means for rotational actuation of a blade about an axis of rotation, and an assembly (200) for translational actuation of the first support element (124) with respect to the second support element (123) so as to vary the interaxial distance between the orbiting axis (x2) and the axis of rotation (x1) of the blade.

The present invention relates to an apparatus and a method for controlling and operating a circular cutting blade, as well as to a machine for cutting rolls from reels with a greater axial length.

It is known, in the technical sector relating to the production of rolls which are cut to size, such as rolls of toilet paper or absorbent paper for various uses, that said rolls are obtained from a whole reel of predefined axial length which is fed, along a feeding direction, which is conventionally longitudinal, corresponding to the lengthwise dimensions of the reel and the roll, to a cutting blade lying in a plane transverse to the longitudinal direction and therefore arranged to perform transverse cuts in the reel in order to obtain a plurality of rolls with an axial length smaller than that of the starting reel.

According to known embodiments, it is also possible to envisage feeding a plurality of reels to the cutting zone, suitably arranging them along the circumference of a predefined circular orbit so that they are all cut in succession by a single circular blade which travels along the orbit, An example of an apparatus with an orbital cutting blade is described in WO 2021/106020 A1.

It is also known that the cutting blade may be correspondingly controlled by control and operating devices designed to rotationally operate the blade about its own axis and to move said blade in its plane along a predefined circular orbit, so as to perform the cutting of each reel fed to the cutting zone. In these circumstances, it is known that the number of reels and the size of the rolls which can be cut in a single orbital pass of the blade depends both on the diameter of the cutting blade and on the diameter of the reels to be cut.

In all the cutting machines it is also the case that the cutting blade is subject to wear which, after a certain number of cuts, results in:
loss of the cutting sharpness on the outer circumferential edge of the blade and consequent need to sharpen repeatedly the blade in order to maintain the efficiency of the cutting system,
a progressive reduction in the diameter of the blade following wear and the subsequent sharpening operations.

As a result, if the orbit of the blade remains fixed, the blade is no longer able to perform the complete cutting of the entire diameter of the rolls which, not being correctly separated from the reel, remain attached, with the result that the system is not compatible with a continuous production cycle, resulting in flawed products which must be discarded.

The technical problem which is posed, therefore, is that of providing an apparatus for controlling and operating a cutting blade, able to compensate for the problems of the prior art, in particular compensate for the reduction in diameter of the roll cutting blade caused by the wear and repeated sharpening so as to be able to use the entire cutting part of the blade and avoid or reduce the machine downtime needed for the repositioning, sharpening or replacement of the said blade and ensure efficient and correct cutting of all the reels.

Preferably, it is also desirable that the apparatus should allow resharpening of the cutting blade during operation of the machine.

A further desirable aspect is that the apparatus should allow greater versatility during the cutting of single or multiple reels with a different diameter.

In connection with this problem, it is also required that this apparatus should have small dimensions, be easy and inexpensive to produce and assemble and be able to be easily installed at any user location using normal standardized connection means.

These results are obtained according to the present invention by an apparatus for controlling and operating a cutting blade according to the features of claim 1.

Preferred embodiments of the apparatus are described in the dependent claims which are fully cited by reference herein.

According to a further preferred aspect of the invention, the apparatus may also comprise a sharpening assembly for sharpening the cutting blade, comprising one or more pairs of grinding wheels for sharpening the cutting blade, said wheels being translatable with respect to the blade between a disengaged position and a position in contact with the blade for sharpening thereof. In particular, the following may be provided: a first pair of grinding wheels for lapping the cutting edge of the blade in order to resharpen it; and/or a second pair of grinding wheels for deep sharpening with stock removal from the cutting edge of the cutting blade.

The use of at least two pairs of grinding wheels with different sharpening characteristics is able to ensure more efficient sharpening, reducing the wear of the cutting part of the blade due to the sharpening and increasing the working life thereof.

Preferably, the wheels of a pair of grinding wheels are arranged, during use, on opposite sides in the longitudinal/axial direction of the cutting blade. A mechanism for actuating the translation of the one of more pairs of grinding wheels towards/away from the blade may be provided for the translational movement of the one or more pairs of grinding wheels. The translational actuation mechanism may in particular comprise a respective slider fixed to the wheels of the pairs of grinding wheels and translatably moved by a screw nut operated by a screw rotated by a respective driving actuator. Alternatively, the translational actuation mechanism may comprise a chain for transmission of the movement from the actuator to the slider by means of a plurality of pulleys connected by a drive belt.

The machine may also comprise coupling means for translatably coupling each pair of grinding wheels and the first support element designed to carry the cutting blade, allowing rotation thereof. The coupling means may in particular comprise a sliding shoe which is translatably integral with the grinding wheels and slides on a guide fixed to a front surface of the first support element and extending parallel to a direction of translation of the grinding wheels.

The present invention relates furthermore to a cutting machine comprising the apparatus for controlling and operating a cutting blade according to claim 18 and a method for controlling and operating a cutting blade according to claim 19.

In preferred embodiments of the apparatus or the control method, means are provided for detecting a sharpness state of the blade, preferably comprising one or more force sensors, designed to detect a cutting stress or a cutting force applied by the blade during the cutting of one or more reels. Said force sensors may be in particular arranged in one or more reel-holder supports in the cutting zone.

Advantageously, a command for starting or ending a sharpening operation may be generated depending on a signal emitted by the sensor means for detecting the cutting force.

In addition or alternatively, it is possible to envisage adjusting the position of the sharpening wheels in relation to the cutting blade depending on a signal generated by the force sensor means, in particular indicating a cutting force or stress applied by the blade during cutting of one or more reels and therefore a sharpness state of the blade.

A further aspect of the present invention relates to a method of cutting rolls from one or more reels of greater axial/longitudinal length, comprising the steps of:
arranging one or more reels to be cut with their axes parallel to a longitudinal direction, the one or more reels being arranged tangentially and internally with respect to a circular cutting orbit O;
rotationally actuating the blade about an axis of rotation and causing an orbiting movement of the blade along the circular orbit about an orbiting axis so as to cut with the cutting blade the rolls from the one or more reels arranged along the cutting orbit;
varying the interaxial distance between the axis of rotation and the orbiting axis of the cutting blade depending on a variation in the diameter of the cutting blade and/or of the circular cutting orbit.

The method further comprises an operation of sharpening the cutting blade by means of one or more pairs of sharpening wheels of a cutting blade sharpening assembly, wherein the one or more pairs of grinding wheels are translatably actuated with respect to the blade between a disengaged position and a position in contact with the blade for sharpening it.

According to preferred embodiments of the machine or the cutting method, initial positioning of the one or more pairs of grinding wheels may be advantageously adjusted depending on a signal obtained from an actuator for the translational actuation of the wheels and indicating a stress thereof determined by the pressure of the wheels on the blade (preferably rotationally operated beforehand).

According to preferred embodiments of the machine or the cutting method, it may be envisaged:
detecting a sharpness state of the blade by means of force sensors, in particular designed to detect a cutting force or stress applied by the blade during the cutting of one or more reels;
controlling the sharpening operation depending on a signal emitted by the force sensor means.

In particular, it is preferably envisaged:
starting or stopping the sharpening operation depending on a sharpness state signal generated on the basis of the detection of the cutting force sensor means; and/or
adjusting the position of the sharpening wheels in relation to the cutting blade depending on a signal generated by the force sensor means, in particular indicating a force or a cutting stress applied by the blade during cutting of one or more reels.

When the sharpening operation is controlled depending on the sharpness state of the blade detected by means of the force sensor means, the blade may be sharpened only when and/or by the amount needed to re-establish the cutting efficiency thereof; therefore, the wear of the cutting part of the blade is reduced and the working life of the blade is prolonged, further reducing the regulation and adjustment operations due to sharpening. Advantageously, the method according to the present invention may be a continuous cutting process, in which sharpening takes place without interrupting the orbital movement and rotation of the cutting blade.

Further details may be obtained from the following description of a non-limiting example of embodiment of the subject of the present invention provided with reference to the attached drawings in which:

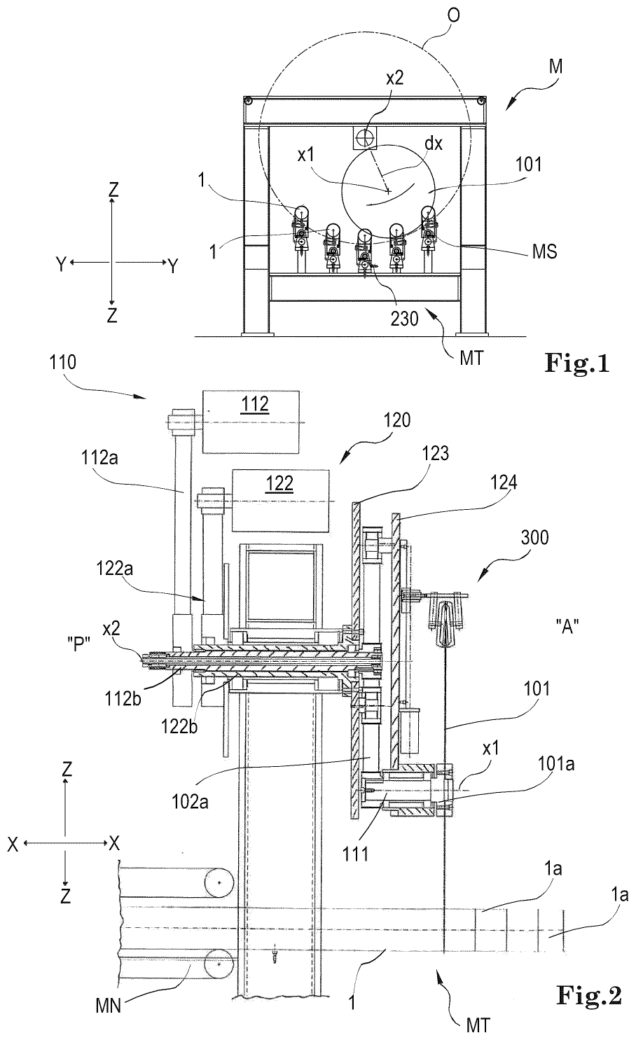

FIG. 1: shows a schematic front view of a cutting machine for obtaining a plurality of rolls, according to the present invention;

FIG. 2: shows a partially cross-sectioned, schematic, side view of the cutting machine according to FIG. 1 with a new blade;

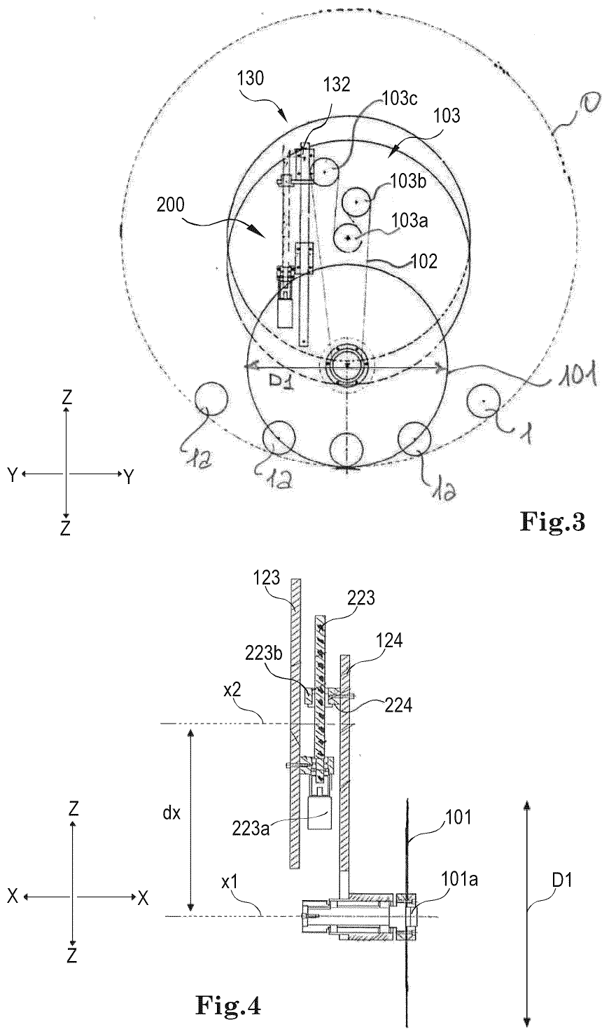

FIG. 3: shows a schematic front view of the machine according to FIG. 2 with a new blade;

FIG. 4: a partially cross-sectioned, schematic, side view of the device for moving and supporting the cutting blade in the condition with a new blade;

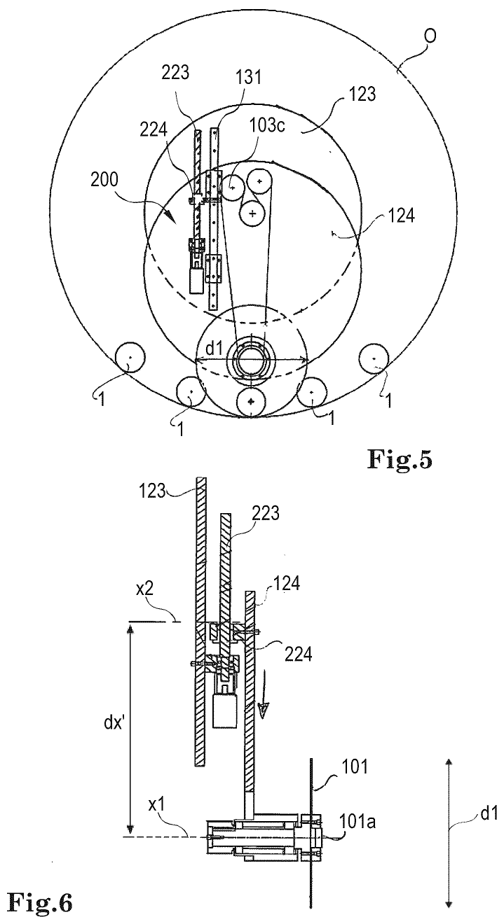

FIG. 5: shows a schematic front view of the cutting machine, with a worn blade brought into the correct cutting position;

FIG. 6: shows a partially cross-sectioned, schematic, side view of the device for moving and supporting the cutting blade according to FIG. 5 in the condition where the blade is worn;

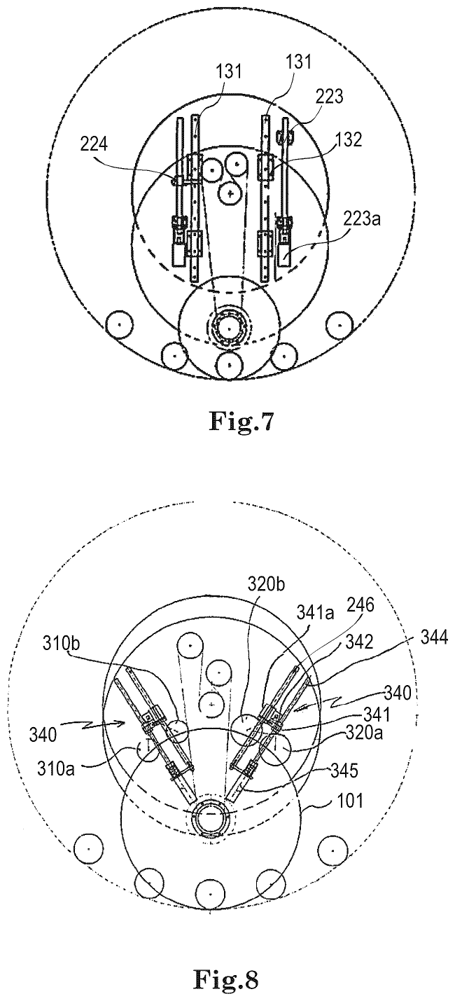

FIG. 7: shows a schematic front view of the apparatus for operating the cutting blade in a variant with double movement device; and

FIG. 8: shows a schematic front view of the devices for continuous sharpening of the cutting blade, installed on an apparatus for controlling and operating the blade.

As shown in FIGS. 1,2 and assuming solely for easier description and without any limiting meaning a set of three reference axes with a respectively: longitudinal/axial direction X-X, parallel to the axes of rotation x1 and the orbiting axis x2 of a blade 101 and to the larger dimension of the reels 1 and the rolls 1a to be cut; transverse/radial direction Y-Y corresponding to the direction of cutting thereof; and vertical direction Z-Z perpendicular to the other two directions; as well as a blade side conventionally assumed as being the front side “A” and an opposite side in the longitudinal direction conventionally assumed as being the rear side “P”, a preferred example of a machine M according to the invention for cutting rolls 1a from reels 1 of greater length comprises a cutting zone MT with a plurality of reel-holder supports MS arranged side-by-side at heights such that a corresponding plurality of reels 1 are arranged with their longitudinal axes parallel and each in a tangential position on the inside of a predefined circular cutting orbit O.

The one or more reels 1 may be fed to the cutting zone MT by means of feeding means, for example comprising belts MN (FIG. 2), chain systems with pushing carriers or other feeding systems.

A circular cutting blade 101 is arranged and operated so as to rotate about its axis of rotation x1.

The blade 101 is also moved rotationally with an orbital movement, about a longitudinal orbiting axis x2, parallel to the axis of rotation x1 of the blade 101, so that the outer cutting edge of the blade 101 follows the predefined circular orbit O for cutting the reels 1 arranged in the cutting zone MT. For this purpose, the cutting machine M comprises an apparatus for controlling and operating the circular blade 101, which comprises a first support element 124, on which the blade 101 is mounted with the possibility of rotating about its axis of rotation x1, operated by an assembly 110 for rotational operation of the blade 101 about the axis of rotation x1 with respect to the first support 124.

In greater detail, in the preferred example illustrated, the blade 101 is mounted on a spindle 101a mounted rotatably on a first support disc 124 (FIGS. 2, 4), in particular in a peripheral position with respect to a centre thereof.

With reference to FIGS. 2,3, the spindle 101a and therefore the blade 101 may be rotationally operated by a shaft 111 coaxial with the axis of rotation x1 and connected to a motor 112 by means of a kinematic chain 112a, 112b, 102,103 (FIG. 3), for example comprising a rotating sleeve 112b extending coaxially with respect to the orbiting axis x2 and connected via means 112a, 103 for transmission of the rotary movement, to the drive motor 112 and to the shaft 11 which operates the spindle 101a supporting the blade 101.

According to a preferred aspect of the invention, the shaft 111 is in particular connected by means of a drive belt 102 to a series of pulleys 103, at least a first drive pulley 103a of which receives the rotational movement from the first rotating sleeve 112b and in particular is rotationally integral with the front end of said sleeve 112b, the rear of which is connected to the drive motor 112.

A second idle pulley 103b is preferably mounted rotating on the second rear support disc, in a fixed position thereon.

For the movement of the blade 101 along the predefined cutting orbit O, a second support element 123, in particular a second disc behind the first disc 124, is rotating about the orbiting axis x2 parallel and axially offset with respect to the axis of rotation x1 of the blade, upon operation of means 120 for rotational actuation of the second support 123, in the example comprising an orbiting motor 122 which by means of a second kinematic chain 122a, 122b is connected to the second disc 123.

Said kinematic chain comprises, among other things, a second outer sleeve 112b which extends parallel to the orbiting axis x2 and inside which the first sleeve 112b is coaxially inserted with the possibility of relative rotation, for example by means of suitable bearings.

The front end of the outer sleeve 122b is rigidly connected to the second rear disc 123; for example, a central hole of the second disc is keyed onto the sleeve onto which it is fixed by means of fixing screws.

The rear end of the sleeve 122b is connected, for example by means of movement transmission means such as a belt 122a (FIG. 2), to the rotating shaft of the orbiting motor 122.

The second disc 123, which lies in a radial plane Z-Y, is therefore fixed in the two directions, i.e. longitudinal direction X-X and vertical direction Z-Z, but rotating with the second sleeve 122b about the orbiting axis x2.

The first disc 124 is parallel and rotationally coupled to the second disc 123 by means of coupling means 130 (shown transparent in FIG. 3) so as to rotate integrally therewith about the orbiting axis x2 so as to cause the movement of the blade 101 along the cutting orbit O.

In greater detail, the centre of the first disc 124 is axially offset with respect to the axis of rotation x2 of the second disc 123, the rotation of which causes the rotation of the first disc 124 and therefore moves the spindle 101a and the blade 101 which are mounted thereon along the circular cutting orbit O. According to an innovative aspect of the invention, the coupling between the first and second discs 123,124 allows the relative translation in the radial direction of the first disc 124 with respect to the second disc 123.

The apparatus also comprises an assembly 200 for translational actuation of the first support element 124 and therefore the cutting blade 101 with respect to the second rotating support element 123, said assembly being designed to vary the interaxial distance dx between the orbiting axis x2 and the axis of rotation x1 of the blade 101, for example following a reduction of its diameter D1.

With reference to FIGS. 3-6, the device 200 for translational actuation of the blade preferably comprises at least one precision screw 223, for example a recirculating ball screw, extending perpendicularly with respect to the orbiting axis x2 and fixed to the second rear disc 123. The screw is rotationally moved by an associated motor 223a so as to cause the translational movement, in both senses of the direction of axial extension of the screw, of a screw nut 223b in turn connected to a slider 224 integral with the first movable disc 124 which carries the first spindle 101a with the blade 101. In other words, the first disc 124 (FIGS. 2,4) is situated axially at the front in the longitudinal/axial direction X-X and parallel to the second disc 123 to which it is rotationally coupled with the possibility to move translationally with respect to the latter perpendicularly to the orbiting axis x2 by means of said movement device 200 which is arranged in between (FIG. 4) the second disc 123 and the first movable disc 124.

Preferably, a third idle pulley 103b is mounted on the second support/disc 123, in a front position, so as to help keep constant a tension of the drive belt.

The means 130 for coupling together the second support element 123 which rotates about the orbiting axis x2 and the first support element 124 which carries the blade 101 ensure the rotational coupling together of the two supports 123,124 and allow relative translation thereof perpendicularly with respect to the orbiting/rotation axis so as to vary the distance between the two axes x1,x2.

Preferably, the coupling means 130 comprise (FIGS. 3,5) a guide 131, in particular a rail, which is fixed to the front surface of the second disc 123 and one or more sliding shoes 132 which are fixed to the rear surface of the first disc 124 and are slidable along the guide 131.

FIG. 7 shows a variation of embodiment of the apparatus which involves duplication of the coupling means 130 and the mechanism 200 for translational actuation of the first disc 124 which supports the blade 101 (visible transparent behind the first disc 124) in order to balance better the rotating masses, reducing the stresses resulting from the first disc 124 being supported cantilevered on the second disc 123. The configuration and the reference numbers remain the same as those of the first embodiment.

In this preferred embodiment, two parallel guides 131 are arranged on the second disc 123 on opposite sides of a diameter passing through the orbiting axis x2 and one or more sliding shoes 132 are arranged on the first disc 124 and coupled with each guide 131.

Preferably, the coupling means 130 are arranged in a radially more inner position than a translational actuation assembly 200 adjacent to them. According to a preferred aspect of the invention, the apparatus also comprises an assembly 300 for sharpening the cutting blade, designed to sharpen it when it becomes worn owing to the deterioration following successive cutting operations, so as to ensure complete and correct cutting of all the rolls 1a with each orbiting movement of the blade 101. Preferably it is envisaged that the sharpening assembly comprises:
a first pair of grinding wheels 310a,310b for lapping the cutting edge of the blade in order to sharpen it without causing a significant reduction in the diameter of the blade; and/or
a second pair of grinding wheels 320a,320b for performing sharpening, being designed to remove material from the cutting blade when simple lapping is no longer sufficient and it becomes necessary to restore the entire cutting edge which has become excessively worn. Therefore, it is possible to maintain a correct sharpening equilibrium and obtain a perfect cut of the product with less wear of the cutting part of the blade, thereby increasing the working life of the blade.

Both pairs of grinding wheels are arranged so as to come into contact with the cutting edge of the blade 101. The single grinding wheels in particular are arranged on opposite sides thereof in the axial direction so as to obtain a cutting edge suitable for the material to be cut, which is preferably as tapered as possible or has a triangular cross-section.

Each pair of grinding wheels is moved towards the blade by an actualing mechanism 340.

In a preferred embodiment of the mechanism 340, each pair of grinding wheels may be connected to a respective slider 341 coupled with the threading 342 of a screw 344 made to rotate by a driving actuator 345. Alternatively, the translational actuating mechanism may comprise a chain for transmission of the movement from the actuator to the slider by means of a plurality of pulleys connected by a drive belt.

For translational coupling together of one pair of grinding wheels and the first disc 124, it may also be envisaged providing a sliding shoe 341a fixed to the respective slider 341 which slides on a guide 246 fixed to the front surface of the first disc 124 and extending parallel to the screw 344 of the actuating mechanism.

Preferably, the two pairs of sharpening wheels are moved together by the actuating mechanism 340. For example, the actuator 345 of one pair of grinding wheels may be controlled depending on the operation of the actuator of the other pair of grinding wheels (using a master/slave logic). The two pairs of grinding wheels may also be arranged at a relative distance in the plane of the blade so as to cause different contact and operating movements, on the blade, of the sharpening wheels compared to those of the lapping wheels.

In order to allow assembly of the cutting blade, the sharpening wheels may be displaced into a position fully removed and disengaged from the blade 101.

Once the blade has been mounted, an initial sharpening position may be adjusted by displacing the grinding wheels towards the blade 101 until contact between wheels and blade is obtained.

Preferably, the initial positioning of the sharpening wheels and the contact position may be controlled depending on a signal which is received from the actuator for translational actuation of the grinding wheels and which indicates a force exerted by it determined by the pressure of the wheels on the blade, greater than a predetermined threshold value. Following the initial positioning of the grinding wheels, the position of the sharpening wheels in relation to the cutting blade (irrespective as to its diameter) may be advantageously controlled depending on a signal indicating the sharpness state of the blade. Preferably, the machine in fact comprises sensor means designed to detect a sharpness state of the blade. In preferred embodiments, these sensor means Include one or more force sensors which are designed to detect a cutting force or stress applied by the blade 101 during the cutting of one or more reels 1. Advantageously, it is possible in this way to detect the fact that the blade no longer cuts correctly since the blade acts with stress on the reel and exerts a cutting force greater than a predefined reference value.

The cutting force sensors may for example include one or more force sensors 230 (for example a load cell) arranged in one or more reel-holder supports MS of the cutting zone, in particular designed to detect the pressing force exerted by the blade 101 on the reel 1. Preferably, at least one force sensor 230 is arranged in the region of a support MS situated centrally from among those arranged in the cutting zone.

Alternatively or in addition, the sharpness state of the blade may be detected depending on a rotational torque signal of the motor for rotationally actuating the blade 101 which indicates an excessive cutting force.

A start command for performing sharpening (lapping and/or deep sharpening) may therefore be emitted depending on a signal indicating a non-sharpness state of the blade generated based on the detection of the sensor means for detecting the cutting force. Similarly, an end-of-sharpening command may be emitted in response to the detection of a correct cutting force by the sensor means, or after a predefined sharpening time.

During sharpening, the position of the one or more grinding wheels with respect to the blade may be adjusted depending on the signal indicating the sharpness state. In particular, the grinding wheels may be displaced towards the blade in order to produce a greater or smaller action (operation) of the lapping wheels and/or of the deep-sharpening wheels on the blade, until the force sensor means indicate that the cutting force applied onto the reels is again within the range of correct values and therefore the blade 101 is cutting again efficiently and the sharpness state of the blade does not require any further action on the part of the grinding wheels.

It is therefore clear how the sharpening system is able to act in order to sharpen the blade automatically only when the blade loses its sharpness, irrespective as to its diameter, allowing the blade to remain operative continuously during the whole of its working life and minimizing the number of rejects due to rolls which are not cut correctly.

According to a further preferred aspect of the invention, a translation of the first front support 124 and therefore of the blade 101, for example required following a variation in diameter of the blade due to sharpening, may be performed on the basis of a blade position signal emitted by one or more sensor devices, for example designed to detect a position of the cutting edge of the blade with respect to a predefined cutting orbit O. These detection devices may for example include an optical sensor positioned on the predefined cutting orbit and designed to detect the presence or absence of an edge of the cutting blade.

The blade position sensor may therefore detect also the absence of the edge of the blade 101 on the orbit O, for example indicating a reduction in diameter of the blade 101 due to wear thereof following a plurality of cutting cycles and optionally sharpening cycles. In this situation also, a translational movement of the front support 124 and therefore of the blade 101 designed to bring the cutting edge into the predefined orbit O may be performed depending on the position signal emitted by the detection sensor. During working operation, the blade becomes worn and the sensor, no longer detecting the cutting edge, again activates the translational movement until the edge is detected as being along the predefined orbit O.

Preferably, the position of the blade with respect to the orbit O is detected with each orbiting movement of the blade 101.

Further sensors and auxiliary servomechanisms, known to the person skilled in the art, may be provided in order to control the movement of the blade 101 and/or of the sharpening wheels.

With this configuration and with reference to FIGS. 3 to 6, the operating principle of the cutting machine is as follows:
the machine is arranged (FIG. 3) with the grinding wheels in the disengaged position for assembly of a blade 1101 with an assigned diameter D1 and rolls 1 positioned along the predefined cutting orbit O;
the blade 101 is mounted on the first support 124 and, if necessary, a translation of the disc 124 is performed until the outer edge of the cutting blade 101 is positioned along the predefined cutting orbit O, for example depending on the signal of the optical sensor for detecting the position of the blade, arranged along the orbit O so as to detect the presence of the cutting edge of the blade.

In particular, it is possible to act on the movement device 210 (FIG. 6) which by operating the screw 223 displaces the first movable disc 124 until the blade is positioned such that the outer cutting edge is travelling along the predefined orbit O;
the sharpening wheels are displaced into the Initial sharpening position determined by the relative contact with the blade 101 detected by means of the actuator for translational actuation of the grinding wheels;
rotation and orbiting of the blade 1 are started and the reel(s) 1 is/are fed to the cutting zone MT, causing them to advance with each cutting cycle, so as to cut, with each passing movement of the blade 101, a corresponding number of rolls 1a of smaller length which are extracted in a known manner not described in detail;
during the succession of cuts, the blade 101 becomes worn owing to the normal wear due to the cuts and any initial sharpening operations;
optionally, the wear (and therefore a reduction in diameter) of the blade may be compensated for with a translation of the blade so as to keep the cutting edge on the predefined orbit O. Said translation may in particular be controlled depending on the position detection signal of the optical sensor which, periodically (for example with each orbiting movement of the blade), detects the presence or absence of the cutting edge along the orbit O;
when the force sensors detect an excessive cutting force, a sharpening operation is started, said operation involving controlling the relative position and the pressure of the lapping and/or deep-sharpening wheels with respect to the blade 101 so as to adjust their operation in order to restore and maintain continuously the correct cutting edge;
the operation of the second pair of sharpening wheels 320a,320b reduces the diameter of the blade 101 to a measurement d1 less than the preceding measurement D1;
it is therefore required to operate the device for movement of the first support disc 124 in order to vary the interaxial distance dx′ between the axis of rotation x1 and the orbiting axis x2 so as to position the cutting edge of the blade 101 with a now smaller diameter d1 into a position such that it travels along the predefined original orbit O;
as shown in FIGS. 3 and 5, the rotation of the blade is ensured by the drive belt 102 which is kept tensioned by means of the movable pulley 103a which varies its position in the radial direction of translation of the first disc 124 from an initial position (FIG. 3) into a displaced position (FIG. 5) in a manner corresponding to the variation dx′-dx in interaxial distance which compensates for the variation D1-d1 in the diameter of the blade 101. In other words, during the displacements of the blade, the pulley 103e which moves with the first support element 124 keeps the tension of the belt 102 constant, ensuring at the same an optimum transmission of the movement.

In the preferred embodiment shown and described, which envisages the presence of the force sensor positioned in the cutting zone on the reel holder and adjustment of the position and therefore the operation of one or more sharpening wheels depending on a signal indicating the cutting force of the blade, the sharpening operation of the lapping wheels and the deep-cutting wheels may be controlled for a given time depending on the sharpness state of the blade, reducing the sharpening operation when the resistance force detected decreases, this indicating the restored cutting efficiency of the blade.

It is therefore clear how the apparatus according to the present invention is able to compensate for the reduction in diameter of the cutting blade caused by wear and/or by the sharpening operations, so as to keep the blade always along the correct orbit and/or allow the use of a same blade with diameter D1 along different cutting orbits, varying the interaxial distance between the axis of rotation x1 and the orbiting axis x2 of the blade, when required by the product to be cut. Therefore, the cutting machine is more versatile with regard to the handing of different quantities and formats of reels to be cut, without the need to replace the cutting blade with one having a different size. It is also clear how the machine according to the invention allows the entire cutting part of the blade to be used in an efficient manner without any variation in performance, while increasing the working life thereof.

The sharpening assembly ensures that the cutting edge of the blade remains efficient, thereby improving the cutting quality and therefore the finish of the small-size rolls which are to be marketed.

Although described in connection with a number of embodiments and a number of preferred examples of implementation of the invention, it is understood that the scope of protection of the present patent is determined solely by the claims below.

1.-22. (canceled)

23. An apparatus for controlling and operating a circular blade for cutting rolls from reels, comprising:
a first support element designed to carry the cutting blade, allowing rotation thereof;
first actuating means for rotational actuation of the blade about an axis of rotation (x1) with respect to the first support element;
a second support element arranged to rotate about a longitudinal orbiting axis (x2) parallel and axially offset with respect to the axis of rotation (x1) of the blade;
wherein the second rotating support element is coupled to the first support element by means of coupling means so that the two support elements rotate together about the orbiting axis (x2);
second actuating means for rotational actuation of the second support element about the orbiting axis (x2) such as to move the blade along a predefined circular cutting orbit (O);
comprising:
the first support element is coupled to the second support element so as to allow relative translation between the two support elements in a radial direction perpendicular to the orbiting axis (x2);
and in that it comprises an assembly for translational actuation of the first support element and therefore of the cutting blade with respect to the second support element so as to vary the interaxial distance between the orbiting axis (x2) and the axis of rotation (x1) of the blade depending on a variation (D1-d1) in the diameter (D1) of the blade and/or of the circular cutting orbit.

24. The apparatus according to claim 23, wherein the first support element includes a first disc, the blade being preferably mounted on a spindle rotatably mounted in a peripheral position with respect to a centre of the first disc.

25. The apparatus according to claim 23, wherein the first actuating means for rotational actuation of the blade include a shaft coaxial with the axis of rotation (x1) and connected to a motor by means of a first kinematic chain.

26. The apparatus according to claim 23, wherein the first kinematic chain comprises a rotating sleeve extending coaxially with respect to the orbiting axis (x2) and connected via transmission means for transmission of the rotary movement to the drive motor and to the shaft which operates the blade.

27. The apparatus according to claim 25, wherein the first kinematic chain comprises a drive pulley, which receives the rotational movement from the first rotating sleeve and in particular is rotationally integral with the front end of said sleeve, and optionally a second pulley mounted on the second support.

28. The apparatus according to claim 25, wherein the first kinematic chain comprises an idle pulley mounted on the first support element and movable translatably therewith.

29. The apparatus according to claim 23, wherein the second support element includes a second disc arranged in a position behind the first support element, in particular the first disc, and rotating about the orbiting axis (x2).

30. The apparatus according to claim 23, wherein the second actuating means for rotational actuation of the second support element comprise an orbiting motor which is connected to the second support element by means of a second kinematic chain.

31. The apparatus according to claim 23, wherein the second kinematic chain comprises a second, outer sleeve extending coaxially with respect to the orbiting axis (x2).

32. The apparatus according to claim 31, wherein the first sleeve is coaxially inserted the second sleeve, with the possibility of relative rotation about the orbiting axis (x2).

33. The apparatus according to claim 31, wherein the front end of the outer sleeve is rigidly connected to the second support element and the rear end of the sleeve is connected by means of movement transmission means to the orbiting motor.

34. The apparatus according to claim 23, wherein the coupling means for coupling the first support element to the second support element and/or the assembly for translational actuation of the first support element with respect to the second support element are arranged between the first and second elements in the longitudinal/axial direction.

35. The apparatus according to claim 23, wherein the assembly for translational actuation of the first support element and the cutting blade with respect to the second support element comprises at least one screw fixed to the second support element, a motor for rotationally actuating the screw and a screw nut translationally actuated by the rotation of the screw and connected to a slider integral with the first support element.

36. The apparatus according to claim 23, wherein the coupling means for coupling together the second support element and the first support element comprise at least one guide, in particular a rail, fixed to a front surface of the second support element and one or more sliding shoes fixed to the rear surface of the first support element and slidable along the guide.

37. The apparatus according to claim 23, further comprising an assembly for sharpening the cutting blade.

38. The apparatus according to claim 23, further comprising one or more detection devices designed to detect a position of the cutting edge of the blade with respect to a predefined cutting orbit (O) and/or a variation in diameter of the blade; the apparatus being configured to perform the translation of the first support element and therefore the variation of the interaxial distance between the axis of rotation (x1) and the orbiting axis (x2) depending on a detection signal obtained by means of one or more of said detection devices.

39. The apparatus according to claim 23, wherein the detection devices include at least one optical sensor which can be positioned along the predefined cutting orbit (O) and which is designed to detect the presence or absence of the edge of the cutting blade.

40. A machine (M) for cutting rolls from reels of greater axial length, comprising:
a cutting zone (MT) with one or more reel-holder supports (MS) arranged so as to arrange one or more corresponding reels with their axes parallel and each in a position tangential to and on the inside of a predefined circular cutting orbit (O);
a circular cutting blade mounted on and operated by a control and operating apparatus according to claim 23, so as to rotate about an associated axis of rotation (x1) and to orbit along the cutting orbit (O) about the orbiting axis (x2) so as to cut the rolls from the reels arranged in the cutting zone (MT).

41. A method for controlling and operating a cutting blade for cutting rolls from a reel of greater axial/longitudinal length, comprising the steps of:
arranging one or more reels to be cut with their axes parallel to a longitudinal direction, the one or more reels being arranged tangentially and internally with respect to a circular cutting orbit (O);
rotationally actuating a cutting blade about an axis of rotation (x1) by means of first actuating means and causing, by means of second actuating means, an orbiting movement of the blade along the circular orbit (O) about an orbiting axis (x2) parallel and axially offset with respect to the axis of rotation (x1) of the blade, so as to cut the rolls from the one or more reels arranged on the cutting orbit (O);
varying the interaxial distance (dx) between the axis of rotation (x1) and the orbiting axis (x2) of the cutting blade depending on a variation (D1-d1) in the diameter (D1) of the cutting blade and/or of the circular cutting orbit.

42. The method according to claim 41, wherein the cutting blade is mounted on a first support element so as to be able to rotate about the axis of rotation (x1), the first support element being rotationally coupled by means of coupling means to a second support element designed to rotate about the orbiting axis (x2); the method comprising:
rotationally actuating the second support about the orbiting axis (x2) by means of the second actuating means so as to cause the orbiting movement of the blade along the circular orbit (O) and cutting of the rolls from the one or more reels arranged on the cutting orbit (O);
varying the interaxial distance (dx) between the axis of rotation (x1) and the orbiting axis (x2) of the cutting blade by means of an assembly for translational actuation, in the radial direction, of the first support element and therefore of the blade with respect to the second support element, depending a variation (D1-d1) in diameter (D1) of the cutting blade and/or of the circular cutting orbit.

43. The method according to claim 41, further comprising sharpening of the cutting blade, said variation in diameter being a reduction (D1-d1) in diameter due to the wear and/or sharpening of the blade itself.

44. The method according to claim 41, wherein the translation of the first support and therefore the variation in the interaxial distance between the axis of rotation (x1) and the orbiting axis (x2) is performed depending on a detection signal obtained by means of one or more detection devices arranged and configured to detect a position of the cutting edge of the blade with respect to the predefined cutting orbit (O) and/or a variation in diameter of the blade.
